(19) United States
(12) Patent Application Publication
(10) Pub. No.: US 2018/0350082 A1
(43) Pub. Date: Dec. 6, 2018

(54) METHOD OF TRACKING MULTIPLE OBJECTS AND ELECTRONIC DEVICE USING THE SAME

(71) Applicant: AMBIT MICROSYSTEMS (SHANGHAI) LTD., Shanghai (CN)

(72) Inventor: CHIH-HAO CHEN, New Taipei (TW)

(21) Appl. No.: 15/653,556

(22) Filed: Jul. 19, 2017

(30) Foreign Application Priority Data
May 31, 2017 (CN) 201710396372.4

(51) Int. Cl. G06T 7/292; G06K 9/00

(52) U.S. Cl. CPC G06T 7/292; G06K 9/00375; G06K 9/00201; G06K 9/00771

(57) ABSTRACT

A method of tracking multiple objects implements 2D tracking operations on at least a first target object and a second target object residing in a preset area, and determines whether the first target object or the second target object is covered or obscured. If the first target object or the second target object is covered, 3D tracking operations are implemented on the first target object and the second target object, until the covered state no longer exists, to reduce workload of computer processing.

### FIELD

The subject matter herein generally relates to tracking and an electronic device using the same.

### BACKGROUND

A security system can run under a three-dimensional (3D) tracking mode for monitoring multiple objects in an area. However, the 3D tracking mode creates huge data amounts that requires complex operations, increasing workload of a central processing unit (CPU).

### BRIEF DESCRIPTION OF THE DRAWINGS

Implementations of the present technology will be described, by way of example only, with reference to the attached figures, wherein:

FIG. 1 illustrates an exemplary embodiment of the architecture of an electronic device;

FIG. 2 illustrates a block diagram of an exemplary embodiment of a two-dimensional (2D) image generated by 2D tracking operations;

FIG. 3 illustrates a flowchart of an exemplary embodiment of a method of tracking multiple objects;

FIG. 4 illustrates a flowchart of an exemplary embodiment of the step S10 shown in FIG. 3;

FIG. 5 illustrates a flowchart of an exemplary embodiment of the step S20 shown in FIG. 3;

FIG. 6 illustrates a flowchart of an exemplary embodiment of the step S20A shown in FIG. 3;

FIG. 7 illustrates a flowchart of an exemplary embodiment of the step S30 shown in FIG. 3;

FIG. 8 illustrates a flowchart of an exemplary embodiment of the step S40 shown in FIG. 3; and

FIG. 9 illustrates a flowchart of another exemplary embodiment of a method of tracking multiple objects.

### DETAILED DESCRIPTION

It will be appreciated that for simplicity and clarity of illustration, where appropriate, reference numerals have been repeated among the different fingers to indicate corresponding or analogous elements. In addition, numerous specific details are set fourth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. Also, the description is not to be considered as limiting the scope of the embodiments described herein. The drawings are not necessarily to scale and the proportions of certain parts may be exaggerated to better illustrate details and features of the present disclosure.

It should be noted that references to “an” or “one” embodiment in this disclosure are not necessarily to the same embodiment, and such references mean “at least one.”

In general, the word “module” as used hereinafter, refers to logic embodied in computing or firmware, or to a collection of software instructions, written in a programming language, such as, Java, C, or assembly. One or more software instructions in the modules may be embedded in firmware, such as in an erasable programmable read only memory (EPROM). The modules described herein may be implemented as either software and/or computing modules and may be stored in any type of non-transitory computer-readable medium or other storage device. Some non-limiting examples of non-transitory computer-readable media include CDs, DVDs, BLU-RAY, flash memory, and hard disk drives. The term “comprising”, when used, means “including, but not necessarily limited to”; it specifically indicates open-ended inclusion or membership in a so-described combination, group, series, and the like.

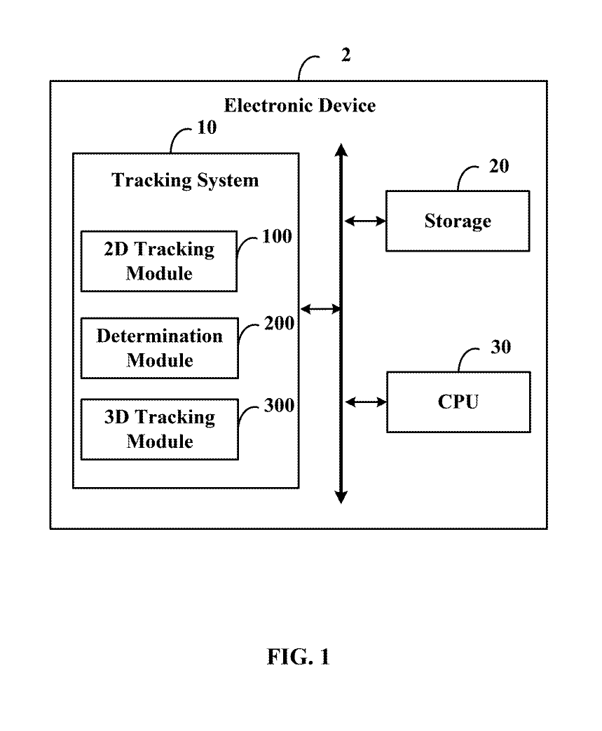

FIG. 1 illustrates an exemplary embodiment of the architecture of an electronic device 2. In the exemplary embodiment, the electronic device 2 comprises a tracking system 10, a storage 20, and a CPU 30. The electronic device 2 may be a mobile phone, a laptop, a set-top box, a smart television (TV), or a security device. The electronic device 2 may have internal sensing devices or be connected with sensing devices, such as motion-sensing devices, image capturing devices, image-depth detecting devices, and the like. The electronic device 2 may also be a motion-sensing device which has an internal image capturing device.

The tracking system 10 comprises a 2D tracking module 100, a determination module 200, and a 3D tracking module 300. The function of each of the modules 100-300 is executed by one or more processors (e.g. by the processor 30). Each module of the present disclosure is a computer program or segment of a program for completing a specific function. The memory 20 may be a non-transitory storage medium, storing the program codes and other information of the tracking system 10.

The 2D tracking module 100 implements 2D tracking operations on multiple objects in an area. The tracking operations sense objects on a 2D plane to obtain images of each of the objects on the 2D plane, and monitors movements of the objects. In an embodiment, when a first target object A and a second target object B enter the preset area, the 2D tracking module 100 tracks implements the tracking operations on the first target object A and the second target object B.

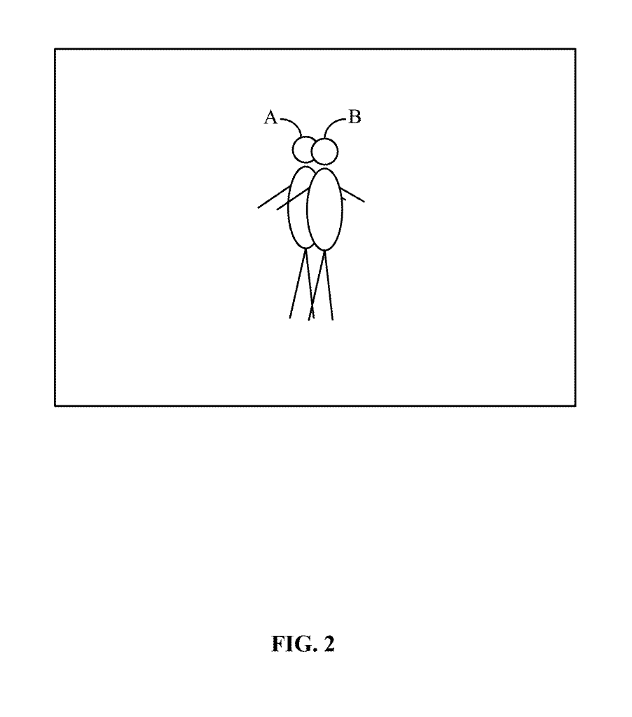

In an embodiment, as shown in FIG. 2, the 2D tracking module 100 detects the first target object A and the second target object B and captures images and data thereof via first preset frequency using a motion-sensing device. The data is in 2D form, and 2D images are generated on the 2D plane according to the 2D data. It is noted that the 2D images comprise at least one first 2D image corresponding to the first target object A and at least one second 2D image corresponding to the second target object B. In another embodiment, the tracking module 100 obtains the first 2D image corresponding to the first target object A and the second 2D image corresponding to the second target object B via an image capturing device.

The determination module 200 determines whether the first target object A and/or the second target object B is covered or obscured. Covered states comprise (1) the first target object A being completely or partly covered by the second target object B or (2) the first target object A or the second target object B being completely or partly covered or hidden by other objects. The present disclosure is further described in light of the covered state (1).

The determination module 200 determines whether the first 2D image is overlapped with the second 2D image. If the first 2D image is overlapped with the second 2D image, the covered state (1) is detected as applying.

In an embodiment, the step for determining the fact of the covered state further comprises the following steps. A first 2D location message for the first 2D image on the 2D plane and a second 2D location message for the second 2D image on the 2D plane are obtained. A distance between the first 2D image and the second 2D image is determined according to the first 2D location message and the second 2D location message. The distance being less than a predetermined threshold value means the first 2D image is overlapped with the second 2D image. The distance being not less than a predetermined threshold value means the first 2D image is not overlapped with the second 2D image. It is noted that the distance, between the first target object A and the second target object B and the electronic device 2, is positively correlated to proportion of the first 2D image and the second 2D image.

The 3D tracking module 300 implements the tracking operations on the first target object A and the second target object B when the first target object A and/or the second target object B is covered.

During the implementation of the tracking operations, the determination module 200 can determine if and when the covered state no longer exists. If the covered state no longer exists, the 3D tracking module 300 terminates the tracking operations which are taken over by the 2D tracking module 100.

In the present embodiment, the 3D tracking module 300 detects the first target object A and the second target object B via second preset frequency to obtain 3D data and generates a 3D model according to the 3D data. The 3D model comprises a first 3D image corresponding to the first target object A and a second 3D image corresponding to the second target object B. The determination module 200 can obtain a first 3D location message for the first 3D image on the 3D model and a second 3D location message for the second 3D image on the 3D model, and can also determine if and when the covered state no longer exists. If the covered state is no more, the 3D tracking module 300 terminates the tracking operations and instructs the 2D tracking module 100 to re-perform the tracking operations.

In an embodiment, the 3D tracking module 300 detects and captures the first target object A and the second via a motion-sensing device (or an image capturing device) and an image-depth message detecting device. The motion-sensing device acquires 2D data of the first target object A and the second target object B, while the image-depth message detecting device acquires depth information as to the first target object A and the second target object B. It is noted that the 3D tracking module 300 generates the 3D model according to the 2D data sensed and the depth information. The 3D model comprises the first 3D image and the second 3D image which are proportionally enlarged and reduced based on the preset area.

The first 3D location message of the first 3D image in the 3D model may be a relative coordinate value that takes the electronic device 2 as an origin of coordinates. The X and Y values of the relative coordinate value are used to mark the first 2D location message and the second 2D location message of the first target object A and the second target object B on the 2D plane. The Z value of the relative coordinate value is used to mark the distance between the first target object A and the second target object B and the electronic device 2. When the first 3D location message and the second 3D location message are obtained, the determination module 200 determines whether the covered state has ceased to exist according to the X-Y coordinate values of the first 3D location message and the X-Y coordinate values of the second 3D location message.

The electronic device 2 further comprises a collecting module (not shown) which is used to improve tracking accuracy. Before tracking a first user A and a second user B (A and B being objects in images captured), the collecting module pre-collects first human body characteristic messages of the first user A and second human body characteristic messages of the second user B. The first human body characteristic messages are used for identifying the first user A, while the second human body characteristic messages are used for identifying the second user B. In an embodiment, the first human body characteristic messages comprise first human body coordinate messages for various preset postures of the first user A, while the second human body characteristic messages comprise second human body coordinate messages for various preset postures of the second user B.

To increase accuracy of determination for determining covered or uncovered states, the first and second human body coordinate messages comprise one or more of the followings: head coordinates, left-shoulder coordinates, right-shoulder coordinates, left-elbow coordinates, right-elbow coordinates, left-leg coordinates, right-leg coordinates, cervical vertebra coordinates, and bone fulcrums. A first sub-location message of a first preset human body portion of the first 2D image is determined by the first human body coordinate messages, while a second sub-location message of a second preset human body portion of the second 2D image is determined by the second human body coordinate messages. The first preset human body portion may be the left shoulder, the right shoulder, the left elbow joint, the right elbow joint, the left leg joint, the right leg joint, or the cervical vertebra. The first sub-location message may correspond to the left shoulder coordinates, the right shoulder coordinates, the left elbow joint coordinates, the right elbow joint coordinates, the left leg joint coordinates, or the right leg joint coordinates.

When the first user A and the second user B move in the preset region, the 2D tracking module 100 identifies and tracks the first user A according to the first human body characteristic messages using the motion-sensing device. The second user B is also identified and tracked according to the second human body characteristic messages using the motion-sensing device, and the first user A and the second user B are projected on the 2D plane. The 2D plane comprises the first 2D image of the first user A and the second 2D image of the second user B.

The determination module 200 identifies the first cervical vertebra coordinates of the first user A according to the first 2D location message and the first human body coordinate message of the first user A, identifies the second cervical vertebra coordinates of the second user A according to the second 2D location message and the second human body coordinate message of the second user B, and calculates a distance between the first cervical vertebra coordinates and the second cervical vertebra coordinates. The distance being less than a predetermined threshold value indicates that the first user A and the second user B are so close together that one must be completely or partly covered by the other.

When one of the first user A and the second user B is completely or partly covered by the other, the 3D tracking module 300 implements the tracking operations on the first user A and the second user B until the determination module 200 determines that the covered state no longer exists. During the 3D tracking operations, locations of the first user A and the second user B can be differentiated according to the depth message of the first user A and the depth message of the second user B for implementing effective tracking operations on the first user A and the second user B.

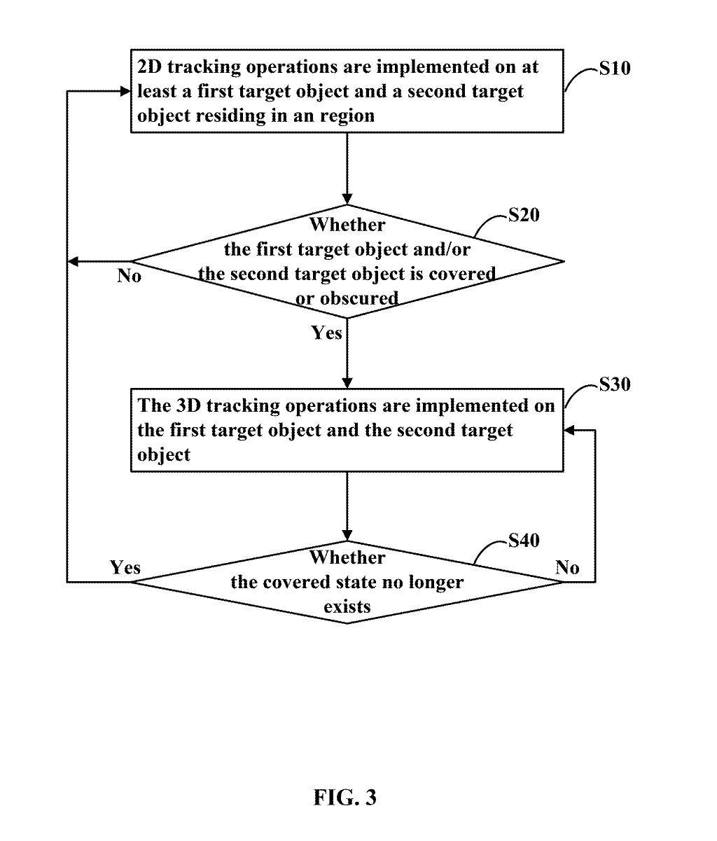

FIG. 3 illustrates a flowchart of an exemplary embodiment of a method of tracking multiple objects. The method is provided by way of example, as there are a variety of ways to carry out the method. The method described below can be carried out using the electronic device 2 illustrated in FIG. 1, for example, and various elements of these fingers are referenced in explaining the processing method. The electronic device 2 is not to limit the operation of the method, which also can be carried out using other devices. Each step shown in FIG. 3 represents one or more processes, methods, or subroutines, carried out in the exemplary processing method. Additionally, the illustrated order of blocks is by example only and the order of the blocks can change. The method begins at block S10.

At block S10, 2D tracking operations are implemented on at least a first target object and a second target object in an region.

At block S20, it is determines whether the first target object and/or the second target object is covered or obscured and, if so, the process proceeds with the block S30, and, if not, to the block S10.

At block S30, 3D tracking operations are implemented on the first target object and the second target object.

At block S40, it is determined whether the covered state is no longer exists and, if so, the process proceeds with the block S10, and, if not, to the block S30.

When there is no object is monitored in the preset region, the electronic device 2 is terminated or works in a standby mode.

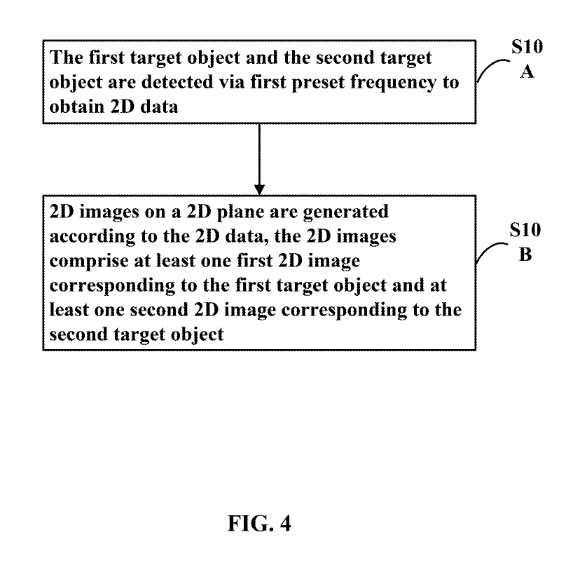

FIG. 4 illustrates a flowchart of an exemplary embodiment of the step S10 shown in FIG. 3.

At block S10A, the first target object and the second target object are detected and images and data thereof are captured via first preset frequency to obtain 2D data.

At block S10B, 2D images on a 2D plane are generated according to the 2D data. The 2D images comprise at least one first 2D image corresponding to the first target object and at least one second 2D image corresponding to the second target object.

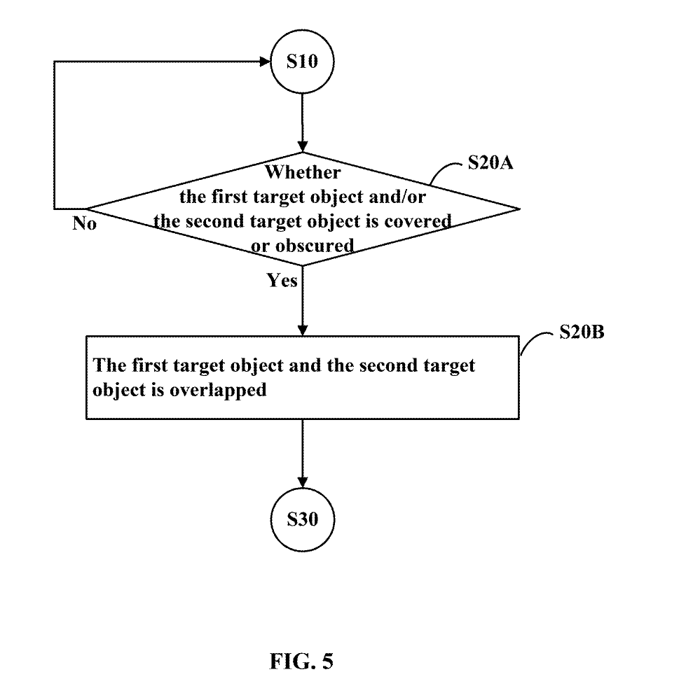

FIG. 5 illustrates a flowchart of an exemplary embodiment of the step S20 shown in FIG. 3.

At block S20A, it is determines whether the first target object and the second target object are overlapped or obscured and, if so, the process proceeds with the block S20B, and, if not, to the block S10.

At block S20B, the first target object and the second target object is overlapped or obscured, and the process proceeds with the block S30.

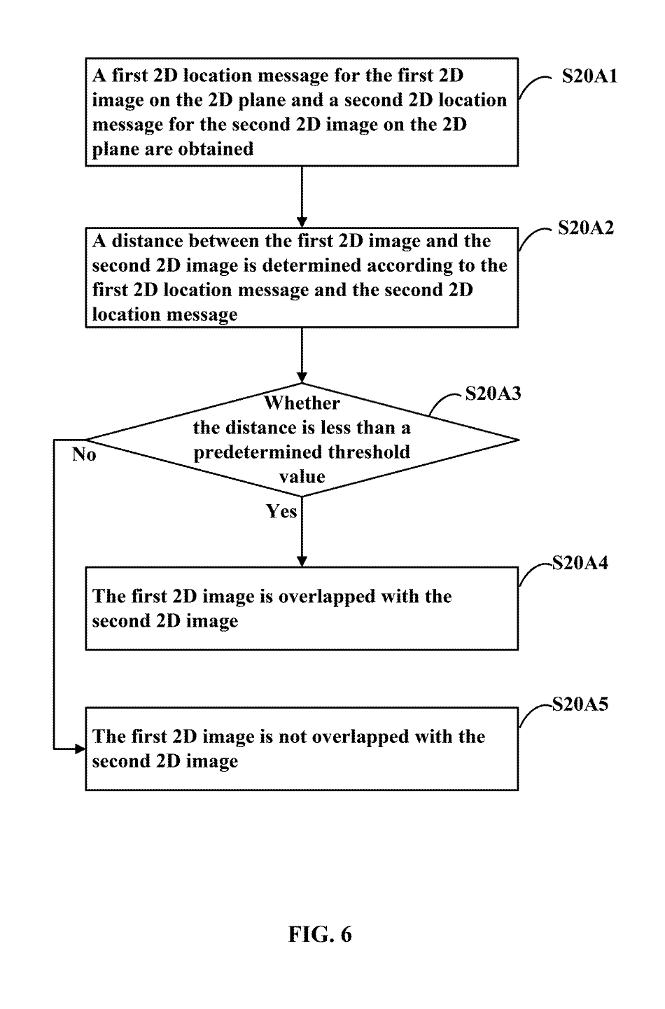

FIG. 6 illustrates a flowchart of an exemplary embodiment of the step S20A shown in FIG. 3.

At block S20A1, a first 2D location message for the first 2D image on the 2D plane and a second 2D location message for the second 2D image on the 2D plane are obtained.

At block S20A2, a distance between the first 2D image and the second 2D image is determined according to the first 2D location message and the second 2D location message.

At block S20A3, it is determined whether the distance is less than a predetermined threshold value and, if so, the process proceeds with the block S20A4, and, if not, to the block S20A5.

At block S20A4, the first 2D image is overlapped with the second 2D image when the distance is less than a predetermined threshold value.

At block S20A5, the first 2D image is not overlapped with the second 2D when the distance is not less than a predetermined threshold value image.

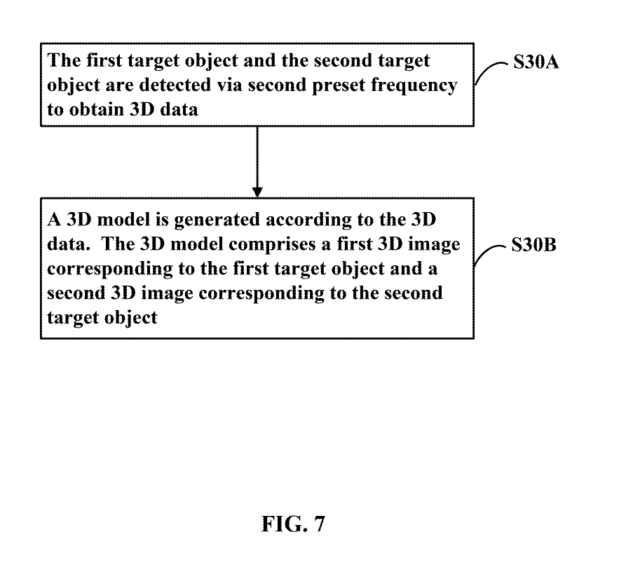

FIG. 7 illustrates a flowchart of an exemplary embodiment of the step S30 shown in FIG. 3.

At block S30A, the first target object and the second target object are detected via second preset frequency to obtain 3D data.

At block S30B, a 3D model is generated according to the 3D data. The 3D model comprises a first 3D image corresponding to the first target object and a second 3D image corresponding to the second target object.

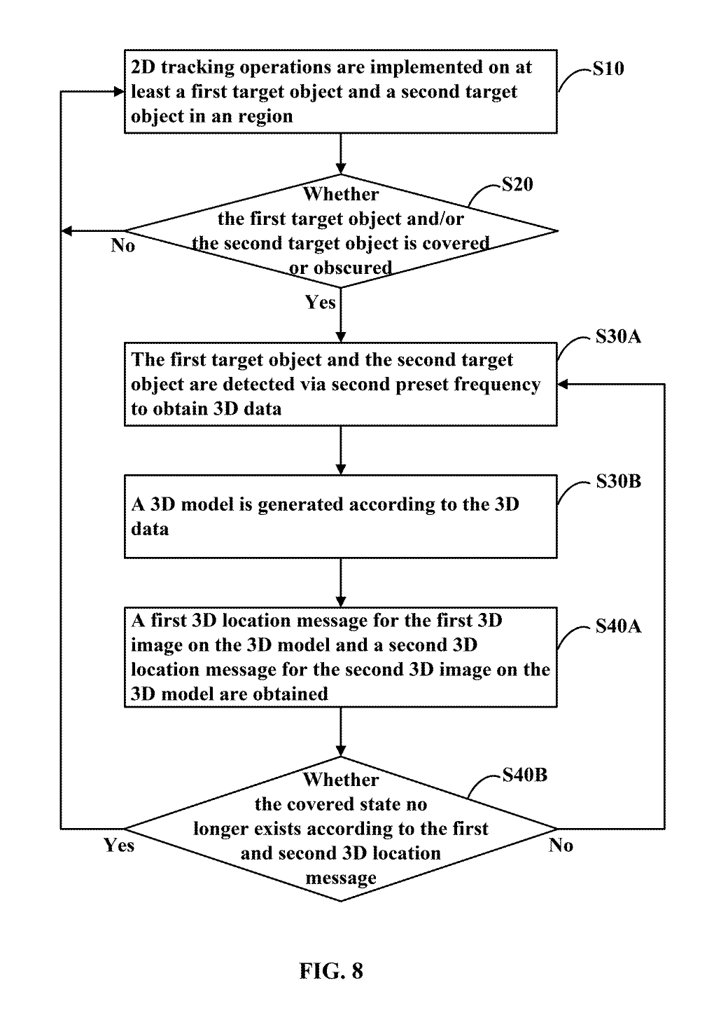

FIG. 8 illustrates a flowchart of an exemplary embodiment of the step S40 shown in FIG. 3.

At block S40A, a first 3D location message for the first 3D image on the 3D model and a second 3D location message for the second 3D image on the 3D model are obtained.

At block S40B, it is determined whether the covered state no longer exists according to the first 3D location message and the second 3D location message, and, if so, the process proceeds with the block S10, and, if not, to the block S30.

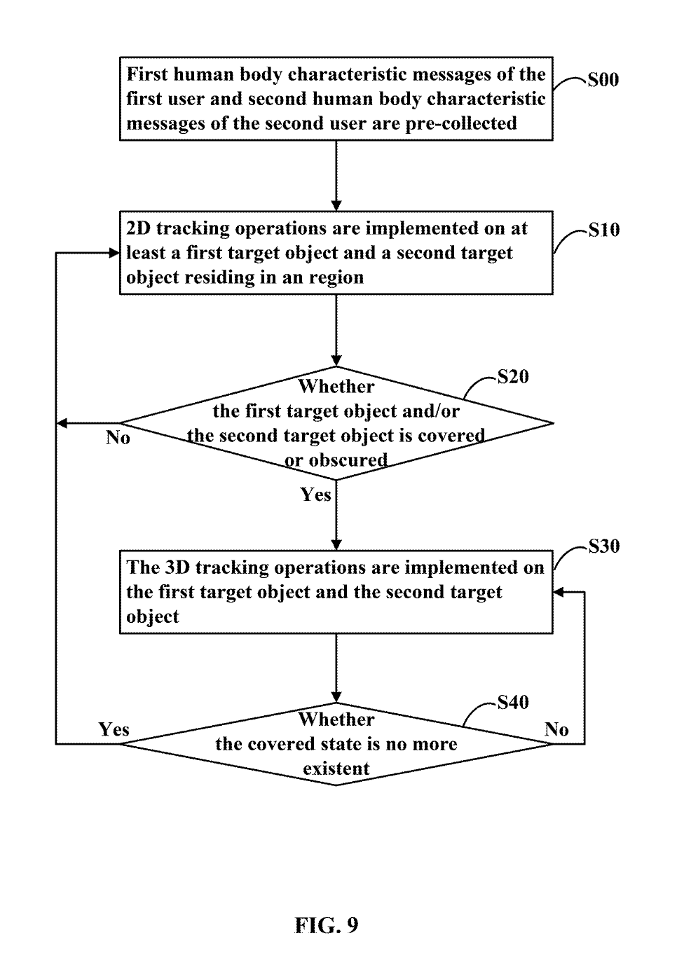

FIG. 9 illustrates a flowchart of another exemplary embodiment of a method, which further comprises the block S00 based on FIG. 3.

In an embodiment, the first target object is a first user, while the second target object is a second user. As shown in FIG. 9, at block S00, first human body characteristic messages of the first user and second human body characteristic messages of the second user are pre-collected. The first human body characteristic messages are used for identifying the first user, while the second human body characteristic messages are used for identifying the second user.

The first human body characteristic messages comprise first human body coordinate messages for various preset postures of the first user, while the second human body characteristic messages comprise second human body coordinate messages for various preset postures of the second user. The first and second human body coordinate messages comprise one or more of the followings: head coordinates, left-shoulder coordinates, right-shoulder coordinates, left-elbow coordinates, right-elbow coordinates, left-leg coordinates, right-leg coordinates, cervical vertebra coordinates and bone fulcrums.

A first sub-location message of a first preset human body portion of the first 2D image is determined by the first human body coordinate messages, while a second sub-location message of a second preset human body portion of the second 2D image is determined by the second human body coordinate messages.

A distance between the first 2D image and the second 2D image is determined according to the first 2D location message and the second 2D location message. First cervical vertebra coordinates of the first user according to the first 2D location message and the first human body coordinate message of the first user are identified. Second cervical vertebra coordinates of the second user according to the second 2D location message and the second human body coordinate message of the second user are identified. A distance between the first cervical vertebra coordinates and the second cervical vertebra coordinates is calculated. The distance being less than a predetermined threshold value indicates that the first user A and the second user B are so close together that one must be completely or partly covered by the other.

It should be emphasized that the above-described exemplary embodiments of the present disclosure, including any particular embodiments, are merely possible examples of implementations, set fourth for a clear understanding of the principles of the disclosure. Many variations and modifications can be made to the above-described embodiment(s) of the disclosure without departing substantially from the spirit and principles of the disclosure. All such modifications and variations are intended to be included herein within the scope of this disclosure and protected by the following claims.

What is claimed is:

1. A method of tracking multiple objects comprising:
at least one processor;
a non-transitory storage medium coupled to the at least one processor and configured to store one or more programs to be executed by the at least one processor, the one or more programs including instructions for:
implementing 2D tracking operations on at least a first target object and a second target object residing in an region;
determining whether the first target object or the second target object is covered or obscured; and
if the first target object or the second target object is covered or obscured, implementing 3D tracking operations on the first target object and the second target object, until the covered state no longer exists.

2. The method of claim 1, wherein the step of implementing the 2D tracking operations further comprises:
detecting the first target object and the second target object via first preset frequency to obtain 2D data; and
generating 2D images on a 2D plane according to the 2D data, wherein the 2D images comprise at least one first 2D image corresponding to the first target object and at least one second 2D image corresponding to the second target object.

3. The method of claim 3, wherein the determining step further comprises:
determining whether the first target object is covered or obscured by the second target object.

4. The method of claim 3, wherein the cover determination step further comprises:
obtaining a first 2D location message for the first 2D image on the 2D plane and a second 2D location message for the second 2D image on the 2D plane;
determining a distance between the first 2D image and the second 2D image according to the first 2D location message and the second 2D location message;
determined whether the distance is less than a predetermined threshold value;
determining that the first 2D image is covered or obscured by the second 2D image when the distance is less than the predetermined threshold value; and
determining that the first 2D image is not covered or obscured by the second 2D when the distance is not less than the predetermined threshold value image.

5. The method of claim 3, the step of implementing the 3D tracking operations further comprises:
detecting the first target object and the second target object via second preset frequency to obtain 3D data;
generating a 3D model according to the 3D data, wherein the 3D model comprises a first 3D image corresponding to the first target object and a second 3D image corresponding to the second target object;
obtaining a first 3D location message for the first 3D image on the 3D model and a second 3D location message for the second 3D image on the 3D model;
determining whether the covered state no longer exists according to the first 3D location message and the second 3D location message; and
stopping the 3D tracking operations and implementing the 2D tracking operations on the first target object and the second target object if the covered state is no longer exists.

6. The method of claim 5, wherein the first target object is a first user and the second target object is a second user, the method further comprising:
pre-collecting first human body characteristic messages of the first user and second human body characteristic messages of the second user, wherein the first human body characteristic messages are used for identifying the first user, while the second human body characteristic messages are used for identifying the second user.

7. The method of claim 6, wherein the first human body characteristic messages comprise first human body coordinate messages for various preset postures of the first user, the second human body characteristic messages comprise second human body coordinate messages for various preset postures of the second user

8. The method of claim 7, further comprising:
determining a first sub-location message of a first preset human body portion of the first 2D image by the first human body coordinate messages
determining a second sub-location message of a second preset human body portion of the second 2D image by the second human body coordinate messages; and
determining a distance between the first 2D image and the second 2D image according to the first 2D location message and the second 2D location message

9. The method of claim 7, wherein the first and second human body coordinate messages comprise one or more of the followings: head coordinates, left-shoulder coordinates, right-shoulder coordinates, left-elbow coordinates, right-elbow coordinates, left-leg coordinates, right-leg coordinates, cervical vertebra coordinates and bone fulcrums.

10. An electronic device, comprising:
at least one processor;
a non-transitory storage medium coupled to the at least one processor and configured to store one or more programs to be executed by the at least one processor, the one or more programs including instructions for:
implementing 2D tracking operations on at least a first target object and a second target object residing in an region;
determining whether the first target object or the second target object is covered or obscured; and
if the first target object or the second target object is covered or obscured, implementing 3D tracking operations on the first target object and the second target object, until the covered state no longer exists.

11. A non-transitory storage medium storing executable program instructions which, when executed by a processing system in an electronic device, cause the processing system to perform the steps of:
implementing 2D tracking operations on at least a first target object and a second target object residing in an region;
determining whether the first target object or the second target object is covered or obscured; and
if the first target object or the second target object is covered or obscured, implementing 3D tracking operations on the first target object and the second target object, until the covered state no longer exists.
